(19) United States
(12) Patent Application Publication
(10) Pub. No.: US 2026/0001420 A1
(43) Pub. Date: Jan. 1, 2026

(54) APPARATUS FOR ELECTRIC VEHICLE TO ELECTRIC VEHICLE SHORT DURATION ENERGY TRANSFER

(71) Applicant: RICHARD A RILEY, BUFORD, GA (US)

(72) Inventor: RICHARD A RILEY, BUFORD, GA (US)

(21) Appl. No.: 18/756,886

(22) Filed: Jun. 27, 2024

(51) Int. Cl. B60L 53/18

(52) U.S. Cl. CPC B60L 53/18

(57) ABSTRACT

The apparatus is a hardware device so plug-in type electric vehicle owners/operators can help other plug-in type electric vehicles owners/operators during times when the plug-in type electric vehicle has depleted battery charge and is no longer self-power motive. A similar use case is how jumper cables are used by internal combustion engine owner/operators help other internal combustion engine owner/operators starter batteries to start an engine.

### BACKGROUND OF THE INVENTION

The number of plug-in type electric vehicles driven in the USA has significantly increased and therefore increased chance that plug-in type electric vehicles can be stranded due to the unmatched scale of plug-in type electric vehicle charger infrastructure. The apparatus is intended to jump start an electric vehicle in the event the internal battery state of charge has been depleted and the vehicle is not close enough to a usable charging point. The apparatus will connect to two electric vehicles at the connection point where an electric vehicle charger would be connected. The apparatus will mediate the transfer of electric energy from one of the connected vehicles to the other connected vehicle. The apparatus thus provides a circuit for the electric vehicle receiving the transferred electric energy to gain enough charge to proceed to the next available electric vehicle charging point. (Related CPC field of art are: B60L, B60L 3/0046, B60L 1/08, B60L 53/14, B60L 53/18, B60L 53/53, B60L 2200/16, B60L 2210/10.)

### SUMMARY OF THE INVENTION

The apparatus which connects two electric vehicles together to transfer a portion of the electrical energy from vehicle 1 to vehicle 2. The apparatus is comprised of connectors for 2 vehicles, a power conversion manager, a multiconductor cables to establish a low resistance path from each vehicle via connectors to the power conversion manager. The apparatus may also include a point of connection for 12V ICE engine start battery. The power conversion manager will house conductor path connectivity while also facilitating the communication protocols for vehicle 1 and vehicle 2. The power conversion manager will incorporate voltage and current sensing to manage the transfer of energy within safe limits. The power conversion manager will incorporate a HV to LV circuit which will be controlled and managed. The type of connectors selected for the apparatus will rely upon the standardized connector configurations and the interfaces to the plug-in type electric vehicle.

### BRIEF DESCRIPTION OF DRAWINGS

Included below are figures of illustration of how the apparatus could be constructed. FIG. 1 is an electrical schematic which indicates point to point connection of the required conductors for the apparatus to function as prescribed. HV+ and HV− are the point of connection where electrical energy will be managed by the power conversion manager, these nets are designated to be the main path for energy transfer. CP, PP, and PE are control signal nets which the power conversion manager establishes communication to each vehicle and creates a handshake so energy transfer can commence. Connectors for DONOR and RECIPIENT reference common EV charger connectors which may also allow adapters. The multi-conductor cable contains both HV conductors and communications conductors to facilitate respective functions.

FIG. 2 is a modeled representation of how the apparatus could appear.

FIG. 3 is a modeled representation of the power conversion manager and how the power conversion manager could appear.

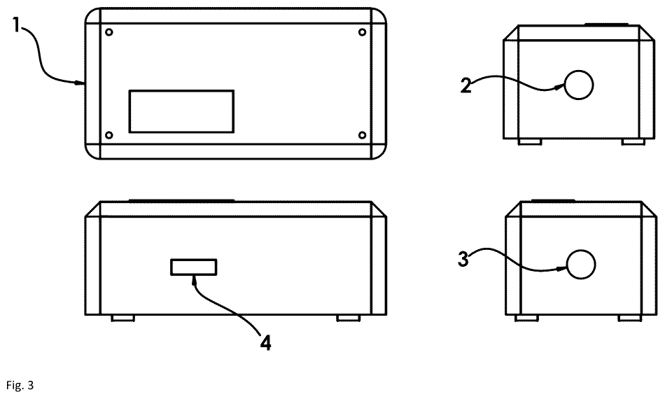

### DETAILED DESCRIPTION OF THE INVENTION

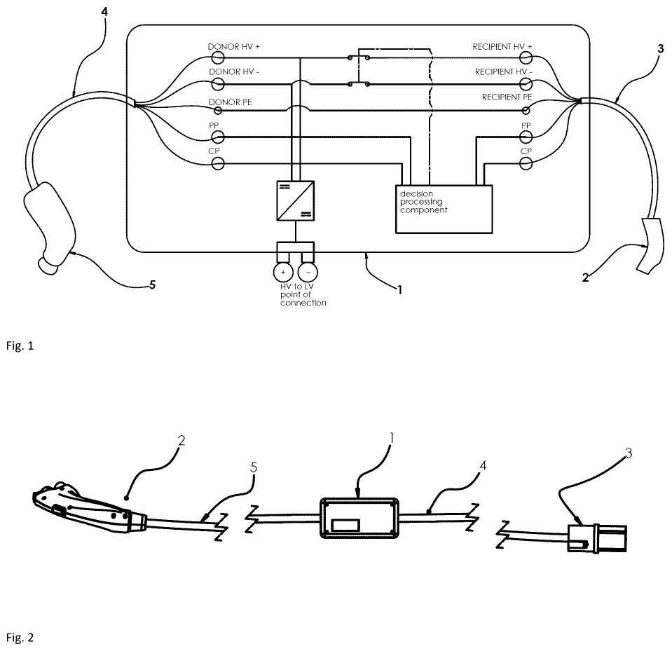

The apparatus FIG. 1 is to be used with plug-in type electric vehicles, which includes battery electric vehicles (BEVs) and pluggable hybrid electric vehicles (PHEVs). The apparatus provides a circuit for plug-in type electric vehicles which has become inoperable due to battery state of charge to receive enough electric charge or “battery range” from a donor plug-in type electric vehicles to drive under self-power to the nearest available operable charge point. Connecting the apparatus to via DONOR connector FIG. 1 5 plug-in type electric vehicles and to RECIPIENT connector FIG. 2 plug-in type electric vehicles will provide a circuit to manage and transfer energy from DONOR HV battery to RECIPIENT HV battery. The way the apparatus accomplishes the transfer of electrical energy from plug-in type electric vehicle to plug-in type electric vehicles is by following the standardized communication protocols which are currently utilized by typical plug-in type electric vehicle chargers and using a multiconductor electrical cable for DONOR FIG. 1 4 and RECIPIENT FIG. 1 3. The apparatus will facilitate a handshake between DONOR and RECIPIENT via the control pilot (CP), control status (CS), and CAN BUS. Once both DONOR and RECIPIENT agree with handshake the contactors internal to plug-in type electric vehicle will close creating a conduction path to the apparatus power conversion module which will make the final conduction path from DONOR battery pack FIG. 1 4 to RECIPIENT battery pack FIG. 1 3. The apparatus power conversion module FIG. 1 1 will monitor voltages and current of electrical energy transfer and make decisions on how much energy to transfer via user input desired amount or battery range. FIG. 2 shows a modeled representation of what the apparatus could look like. With 1 representing the power conversion module, 2 representing connector to either DONOR or RECIPIENT plug-in type electric vehicle, 3 representing connector to either DONOR or RECIPIENT plug-in type electric vehicle, 4 and 5 representing the multiconductor cable to conduct flow or electrical energy and communications.

1. The invention claimed is an apparatus which facilitates and manages the transfer of electrical energy from one plug-in type electric vehicle to another plug-in type electric vehicles for the purpose of providing sufficient energy or battery range so the electric vehicle may operate self-powered to move to an appropriate and operable typical plug-in type electric vehicle charger.
